(19) United States
(12) Patent Application Publication
(10) Pub. No.: US 2020/0234268 A1
(43) Pub. Date: Jul. 23, 2020

(54) SYSTEMS AND METHODS FOR RECOMMENDING FINANCIAL INSTRUMENTS

(71) Applicant: MASTERCARD INTERNATIONAL INCORPORATED, Purchase, NY (US)

(72) Inventor: Manoneet Kohli, White Plains, NY (US)

(21) Appl. No.: 16/250,633

(22) Filed: Jan. 17, 2019

(51) Int. Cl. G06Q 20/22; G06Q 40/02; G06Q 20/08; G06Q 30/02

(52) U.S. Cl. CPC G06Q 20/227; G06Q 30/0215; G06Q 20/0855; G06Q 40/02

(57) ABSTRACT

A method and system for recommending financial instruments in a payment processing network are provided. A purchase recommender computing device is programmed to receive a payment request including a user identifier associated with a user profile for a user, wherein the payment request is generated in response to a wallet system initiating the payment transaction, retrieve, from an instrument management computing device, a financial instrument portfolio associated with the user profile, the financial instrument portfolio including data regarding a plurality of financial instruments available for the user to use in relation to the payment transaction, determine a recommended financial instrument for the payment transaction, determine a final financial instrument based on the recommended financial instrument, generate a modified payment request by updating the payment request to include the final financial instrument, and transmit the modified payment request for the payment transaction.

### BACKGROUND

This disclosure relates generally to financial instruments in a network and, more particularly, to computer systems and computer-based methods for recommending financial instruments within the network.

Many consumers have access to multiple financial instruments (for example, bank accounts, payment cards, installment programs, rewards programs, and promotion programs) when making purchases. These options can be difficult and/or overwhelming to choose from because of the complexity of the differences in the terms, benefits, requirements, and scope for each financial instrument. Some digital wallet applications exist to help consumers make purchases with bank accounts and/or payment cards using an application; however, these applications might not keep track of the details of the financial instruments, such as the terms, benefits, requirements, and scope for the financial instruments. In addition, these applications might not keep track of other financial instruments, such as installment programs, rewards programs, and other promotion programs, and the details of these programs.

### BRIEF DESCRIPTION

In one embodiment, a purchase recommender computer system for recommending financial instruments in a payment processing network is provided. The purchase recommender computer system includes a purchase recommender computing device including at least one processor in communication with at least one memory, the purchase recommender computing device in communication with a payment processing network, an instrument management computing device, and a wallet system. The at least one processor is programmed to receive, from the payment processing network, a payment request for a payment transaction, the payment request including a user identifier associated with a user profile for a user, wherein the payment request is generated in response to the wallet system initiating the payment transaction with a merchant computer system, retrieve, from the instrument management computing device, a financial instrument portfolio associated with the user profile based on the user identifier, the financial instrument portfolio including data regarding a plurality of financial instruments available for the user to use in relation to the payment transaction, determine a recommended financial instrument for the payment transaction based on the payment request and the retrieved financial instrument portfolio, determine a final financial instrument based on the recommended financial instrument, generate a modified payment request by updating the payment request to include the final financial instrument, and transmit the modified payment request for the payment transaction to the payment processing network.

In another embodiment, a computer-implemented method for recommending financial instruments is provided. The method is implemented by a purchase recommender computer system including a purchase recommender computing device having at least one processor in communication with at least one memory, and a display device, the purchase recommender computing device in communication with a payment processing network, an instrument management computing device, and a wallet system. The method includes receiving, by the purchase recommender computing device, from the payment processing network, a payment request for a payment transaction, the payment request including a user identifier associated with a user profile for a user, wherein the payment request is generated in response to the wallet system initiating the payment transaction with a merchant computer system, retrieving, from the instrument management computing device, by the purchase recommender computing device, a financial instrument portfolio associated with the user profile based on the user identifier, the financial instrument portfolio including data regarding a plurality of financial instruments available for the user to use in relation to the payment transaction, determining, by the purchase recommender computing device, a recommended financial instrument for the payment transaction based on the payment request and the retrieved financial instrument portfolio, determining, by the purchase recommender computing device, a final financial instrument based on the recommended financial instrument, generating, by the purchase recommender computing device, a modified payment request by updating the payment request to include the final financial instrument, and transmitting, by the purchase recommender computing device, the modified payment request for the payment transaction to the payment processing network.

In yet another embodiment, at least one non-transitory computer-readable storage media having computer-executable instructions embodied thereon is provided. When executed by at least one processor of a purchase recommender computing device in communication with at least one memory and a display, the computer-executable instructions cause the at least one processor to receive, by the purchase recommender computing device, from a payment processing network, a payment request for a payment transaction, the payment request including a user identifier associated with a user profile for a user, the purchase recommender computing device in communication with the payment processing network, an instrument management computing device, and a wallet system, wherein the payment request is generated in response to the wallet system initiating the payment transaction with a merchant computer system, retrieve, by the purchase recommender computing device, a financial instrument portfolio associated with the user profile based on the user identifier, the financial instrument portfolio including data regarding a plurality of financial instruments available for the user to use in relation to the payment transaction, determine, by the purchase recommender computing device, a recommended financial instrument for the payment transaction based on the payment request and the retrieved financial instrument portfolio, determine, by the purchase recommender computing device, a final financial instrument based on the recommended financial instrument, generate, by the purchase recommender computing device, a modified payment request by updating the payment request to include the final financial instrument, and transmit, by the purchase recommender computing device, a modified payment request for the payment transaction to the payment processing network.

### BRIEF DESCRIPTION OF THE DRAWINGS

FIGS. 1-8 show example embodiments of the methods and systems described herein.

FIG. 1 is a schematic diagram illustrating a purchase recommender system integrated with an example multi-party payment card industry system for enabling payment-by-card transactions in accordance with one embodiment of this disclosure.

FIG. 2 is a simplified block diagram of an example system for recommending financial instruments including a plurality of computer devices in accordance with one example embodiment of the present disclosure.

FIG. 3 illustrates an example configuration of a client system shown in FIG. 2, in accordance with one embodiment of the present disclosure.

FIG. 4 illustrates an example configuration of a server system shown in FIG. 2, in accordance with an embodiment of the present disclosure.

FIG. 5 is a schematic block diagram of an example instrument management system shown in FIG. 2 for managing financial instruments, in accordance with an example embodiment of the present disclosure.

FIG. 6 is a flowchart of a computer-implemented method for recommending financial instruments, which may be implemented using the system shown in FIG. 2.

FIG. 7 is a flowchart of a computer-implemented method for managing financial instruments, which may be implemented using the system shown in FIG. 2.

FIG. 8 is a flowchart of a computer-implemented method for accessing and using a purchase recommender computing device, which may be implemented using the system shown in FIG. 2.

### DETAILED DESCRIPTION

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems utilizing a payment request and a financial instrument portfolio to determine for a user a recommended financial instrument for a payment transaction and to transmit a modified payment request to a payment card interchange network indicating the financial instrument to be used for the payment transaction.

In an example embodiment of the present disclosure, a purchase recommender computing device recommends financial instruments in real time for payment transactions in a payment processing network. The purchase recommender computing device receives, from the payment processing network, a payment request for a payment transaction. The payment request includes a user identifier associated with a user profile for a user. The purchase recommender computing device retrieves a financial instrument portfolio associated with the user profile based on the user identifier. The financial instrument portfolio includes data regarding a plurality of financial instruments available for the user to use in relation to the payment transaction. The purchase recommender computing device uses the financial instrument portfolio to determine a recommended financial instrument.

As used herein, the terms “payment card,” “transaction card,” and “financial transaction card” refer to any suitable payment card, such as a credit card, a debit card, a prepaid card, a charge card, a membership card, a promotional card, a frequent flyer card, an identification card, a prepaid card, a gift card, and/or any other payment device that may hold payment account information, such as mobile phones, smartphones, personal digital assistants (PDAs), key fobs, and/or computers. Each type of payment device can be used as a method of payment for performing a transaction.

As used herein, “financial instrument” refers to any financial mechanism for making an electronic payment transaction, including but not limited to at least one of a bank account, a payment card (for example, a credit card, a debit card, a gift card, a merchant-issued payment card, or other payment card as defined above), an installment program (allowing the payment amount to be paid a portion at a time through a plurality of payments staggered over a period of time, with or without an interest rate), a rewards program (for example, redeeming rewards points to cover the payment amount or using rewards point to secure a discount or special offer regarding the payment), and a promotion program (a special discount applicable in certain circumstances, such as a senior or military discount, or a coupon, a limited time offer, or any other way of paying the payment amount in whole or in part or of arranging payment of the payment amount).

The financial instrument portfolio may be generated by an instrument management system. In such embodiments, the instrument management system receives basic financial instrument data for the user from a wallet system. The basic financial instrument data includes data regarding at least one financial instrument. The basic financial instrument data may, for example, include information necessary to identify and use a payment card, such as a primary account number (PAN), expiration date, security code, and/or account holder information (for example, a name, street address, city, state, country, zip code, and/or telephone number). Or the basic financial instrument data may include simple information about a bank account, such as a bank account number and/or routing number.

The wallet system receives, from the user, the basic financial instrument data. The user may enter the basic financial instrument data into the wallet system on a user computer device (such as a mobile computing device) that includes at least part of the wallet system or is communicatively coupled to the wallet system. The wallet system may also prompt the user to consent to the instrument management system generating the financial instrument portfolio and storing the financial instrument portfolio in at least one location in memory. The wallet system transmits the basic financial instrument data to the instrument management system.

The instrument management system gathers additional financial instrument data from at least one of a bank computer system, an issuer computer system, a payment card interchange network system, a merchant computer system, and an acquirer computer system. The additional financial instrument data relates to at least one of the basic financial instrument data, the user, and a payment transaction associated with the user. Generally, the additional financial instrument data also relates to at least one of a bank account, a payment card, an installment program, a rewards program, and a promotion program.

For example, the additional financial instrument data may include details about a financial instrument associated with the basic financial instrument data. The financial instrument may be a bank account and the details may include a balance, an interest rate, a rewards program associated with the bank account, a current balance of rewards points, rules for earning or spending rewards points, or an amount of rewards points that would be gained as a result of a payment transaction using the bank account. As another example, the additional financial instrument data may include an installment program offered by a merchant acquirer associated with a payment transaction, including details regarding that program, such as an annual percentage rate (APR), an annual percentage yield (APY), a number of installments, a minimum payment amount, a length of an installment period, etc. As yet another example, the additional financial instrument data may include a cash discount or cash back offered by a merchant associated with a payment transaction for payment transactions meeting certain requirements.

Based on the basic financial instrument data and the additional financial instrument data, the instrument management system generates the financial instrument portfolio. The financial instrument portfolio includes data regarding a plurality of financial instruments. In one embodiment the instrument management system generates the financial instrument portfolio as a file (for example, an XML file, a JSON file, a CSV file). The instrument management system may store the file in one or more locations in memory. In another embodiment, the instrument management system generates the financial instrument portfolio as a new row in a database table. Alternatively, the instrument management system may generate the financial instrument portfolio as an updated row in a database table. In yet another embodiment, the instrument management system generates the financial instrument portfolio as structured data (such as an array, a linked list, a hash table, an object, a map, a tree, a graph, etc.). In some embodiments, instrument management computing device may also generate financial instrument portfolios for a user, merchant, merchant acquirer, issuer, payment card interchange network, etc.

When the wallet system initiates a payment transaction with a merchant computer system, the purchase recommender computing device receives a payment request from the payment processing network regarding the payment transaction. As mentioned above, the purchase recommender computing device also retrieves the financial instrument portfolio. Based on the payment request and the retrieved financial instrument portfolio, the purchase recommender computing device determines a recommended financial instrument. The purchase recommender computing device may determine the recommended financial instrument based on at least one of: a net present value, user preferences associated with the user profile, a calculated fraud score, rewards points, an interest rate, a discount, and a machine learning algorithm.

When the purchase recommender computing device determines the recommended financial instrument, it may base the determination on one or more measures by prioritizing or weighting financial instruments based on the one or more measures. The one or more measures may include one or more rules and/or thresholds against which the financial instruments are compared. In some embodiments, the purchase recommender computing device prioritizes financial instruments based on a first measure by breaking down the first measure into tiers (for example, a high tier, a medium tier, and a low tier based on threshold values and/or rankings related to the first measure), and then considering values in a first tier unless no values exist in that tier, and then the purchase recommender computing device considers values in the next tier. The purchase recommender computing device ranks the financial instruments within the tier considered by a second measure and then recommends the financial instrument within the tier considered that has the highest rank based on the second measure. Although in this case the purchase recommender computing device determines the recommended financial instrument based on the second measure, the financial instruments are first prioritized based on the first measure, so the determination is based on both the first and second measures.

In other embodiments, the purchase recommender computing device weights the financial instruments based on a plurality of measures by first normalizing each of the measures within the plurality of measures to be on a comparable scale (such as by converting all measures to a 0 to 100 scale, with 100 being the most desirable value and 0 being the least desirable value) to produce a plurality of normalized measures. For each of the plurality of normalized measures, the purchase recommender computing device uses a respective weighting coefficient representing the weight to be given to the respective normalized measure. The respective weighting coefficients may be retrieved from a user preference, the output of a machine learning algorithm (as discussed more below), or a system default. After normalizing the values, the purchase recommender computing device multiplies, for each financial instrument, each of the plurality of normalized measures for the financial instrument by the respective weighting coefficient to produce a plurality of weighted measures. The purchase recommender computing device then adds the plurality of weighted measures together to produce a weighted sum for each financial instrument. The purchase recommender computing device then determines the recommended financial instrument based on the corresponding weighted sums. In one embodiment, the purchase recommender computing device determines the recommended financial instrument to be the financial instrument with the highest weighted sum. In this way, the determination is based on a plurality of measures.

In some embodiments, the purchase recommender computing device determines the recommended financial instrument by combining prioritizing and weighting by using a weighted sum or weighted sums as the first measure and/or second measure when prioritizing. In other embodiments, the purchase recommender computing device determines the recommended financial instrument based on a single measure.

As used herein, a calculated fraud score may be calculated by a fraud detection system, the calculated fraud score representing the likelihood of theft of information regarding a financial instrument if that financial instrument is used to complete the payment transaction. The purchase recommender computing device may receive calculated fraud scores for the payment transaction for each financial instrument represented in the financial instrument portfolio from a fraud detection system associated with the payment processing network. As with other measures, the purchase recommender computing device may be programmed to prioritize or weight financial instruments based on the calculated fraud scores.

Prioritizing or weighting financial instruments based on calculated fraud scores may help prevent fraud by avoiding use of a financial instrument in situations where the risk of theft of information regarding the financial instrument is high. For example, the purchase recommender computing device may prioritize financial instruments with a calculated fraud score within a first tier of calculated fraud scores (for example, a range of low scores indicating a low probability of theft of information regarding a financial instrument) over financial instruments with a calculated fraud score within a second tier of calculated fraud scores (for example, a range of high scores indicating a high probability of theft of information regarding a financial instrument)

Net present value considers the financial benefit accrued through each financial instrument. Basing the determination of the recommended financial instrument on net present value may result in the purchase recommender computing device determining the recommended financial instrument to be the financial instrument that maximizes monetary value to the user. In some embodiments, net present value may be calculated as the difference between the present value of cash inflows and the present value of cash outflows over a period of time. For a simple example, if the user has a bank account with an APR or APY of 5%, the net present value of a cash payment (a cash outflow) of $105 to be made a year from now (for example, as a payment on an installment plan) may be negative $100 because $100 stored into the bank account today a would become $105 a year from now because of interest. As another simple example, consider a credit card payment (a cash outflow) of $100 made today by the same user using a credit card where no payment on the $100 credit card balance needs to be made for one year, but then the $100 must be paid off, and where the $100 would generate 10% interest over that year. The interest generated would be $10, meaning $110 must be paid off at the end of the year, so the net present value of the credit card payment may be negative $104.76 because $104.76 stored into the bank account today would become $110 a year from now because of interest. Therefore, the cash payment of $105 a year from now (with a net present value of negative $100, indicating a $100 loss) will cost the user less in the long term than the credit card payment of $100 today (with a net present value of negative $104.76, indicating a $104.76 loss).

The purchase recommender computing device may be programmed to consider not only scenarios where the user makes minimum payments (for example, on an installment plan or credit card balance), but also scenarios where the user pays the balance off all at once (for example, the day before any interest is generated or two weeks before any interest is generated). The purchase recommender computing device may treat these different scenarios as different financial instruments even though both scenarios would use the same financial instrument. The purchase recommender computing device may also be programmed to send reminders to the user of upcoming payments (for example, as an email, as an SMS message, or as an application notification).

User preferences associated with the user profile may indicate what priority or weight to give to each factor. For example, the user may indicate that the user wishes to give priority or a higher weight to maximizing rewards points, and the purchase recommender computing device may be programmed to change operation based on this preference by using rewards points that would be generated by a purchase as the first measure when prioritizing, by increasing the respective weighting coefficient for maximizing rewards points, and/or by decreasing other weighting coefficients. If the user indicates that the user wishes to give no weight to a measure, the purchase recommender computing device may cease to use the indicated measure in a prioritization scheme, if applicable, and/or change the respective weighting coefficient for the indicated measure to zero.

Reward points that would be spent or generated by different rewards programs for the same purchase may be normalized in order to allow comparison between them. In one embodiment, rewards points are normalized to a scale from 0 to 1000, with 1000 being the maximum amount of rewards points that can be generated and 0 being no rewards points generated. In another embodiment, rewards points are normalized using an approximate cash value based on the amount of rewards points needed to receive a discount, cash back, or item worth a particular amount. The approximate cash value may be based on an average ratio of rewards points to cash value considering multiple available discounts, cash back opportunities, or items.

In embodiments where rewards points are normalized to an approximate cash value, the normalized rewards points may be combined with net present value to produce a hybrid measure. To calculate this hybrid measure, the approximate cash value of the rewards points that would be generated by a purchase may be added to the net present value, and the approximate cash value of the rewards points that would be spent on a purchase may be subtracted from the net present value.

Discounts and interest rates may be considered separately from other measures or combined with net present value to produce a hybrid measure, taking into account how discounts and interest rates affect the present values of cash inflows and cash outflows.

As used herein, “machine learning” refers to statistical techniques to give computer systems the ability to “learn” (to, for example, progressively improve performance on a specific task) with data, without being explicitly programmed for that specific task. Machine learning algorithms may be used to improve the performance of the purchase recommender computing device. Machine learning algorithms may be used to determine user preferences based on one or more users' patterns regarding which financial instruments the one or more users have historically used for various kinds of purchases. Machine learning algorithms may be used to determine which recommendation schemes financially benefit users the most over time in actual practice. Machine learning algorithms may be used to determine calculated fraud scores based on historical patterns of fraud involving financial instruments. Machine learning algorithms may calculate which measures to consider, the values of the weighting coefficients for a plurality of measures, which measures to give priority to, and other rules that may be helpful in recommending financial instruments.

Optionally, the purchase recommender computing device may further determine multiple recommended financial instruments. The multiple recommended financial instruments may be ranked (for example, in a ranked list) by which financial instruments are most recommended by the purchase recommender computing device for completing the financial transaction. Alternatively, the multiple recommended financial instruments may be categorized, such as by indicating which financial instrument would achieve the highest net present value for the payment transaction, which financial instrument would obtain the most rewards points for the payment transaction, and which financial instrument has the lowest calculated fraud score for the payment transaction.

The purchase recommender computing device determines a final financial instrument based on the recommended financial instrument. In one embodiment, the purchase recommender computing device determines the final financial instrument to be the recommended financial instrument.

In the example embodiment, the purchase recommender computing device determines the final financial instrument by transmitting the recommended financial instrument to the wallet system, which receives the recommended financial instrument. The wallet system instructs a user computer device to display the received recommended financial instrument. The wallet system also instructs the user computer device to prompt the user to either confirm that the recommended financial instrument be used as a selected financial instrument (that is, approve the recommended financial instrument) or select another financial instrument to be used as the selected financial instrument.

The wallet system receives, from the user, via the user computer device, as a response to the prompt, the selected financial instrument. The selected financial instrument may be selected by the user by the user indicating approval of the recommended financial instrument, thereby indicating that the user's selected financial instrument is the approved recommended financial instrument. Or the user may instead indicate that another financial instrument in the financial instrument portfolio is the user's selected financial instrument. The wallet system then transmits the selected financial instrument to the purchase recommender computing device, and the purchase recommender computing device receives the selected financial instrument from the wallet system. The selected financial instrument may be transmitted and received as a unique identifier for the selected financial instrument or as an approval of the recommended financial instrument. The purchase recommender computing device then determines the final financial instrument to be the selected financial instrument. If the selected financial instrument was transmitted and received as a unique identifier for the selected financial instrument, then the final financial instrument will be the financial instrument corresponding to the unique identifier. If the selected financial instrument was transmitted and received as an approval of the recommended financial instrument, then the final financial instrument will be the approved recommended financial instrument.

The purchase recommender computing device transmits, in real time, a modified payment request for the payment transaction to the payment processing network. The modified payment request includes the final financial instrument.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

As used herein, a “processor” may include any programmable system including systems using central processing units, microprocessors, micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium.

The systems and processes are not limited to the specific embodiments described herein. In addition, components of each system and each process can be practiced independent and separate from other components and processes described herein. Each component and process can also be used in combination with other assembly packages and processes.

As used herein, the term “fraud” is used in the context of payment transactions and refers, generally, to any unprivileged use of a payment card or other payment information. For example, a thief may steal a consumer's payment card or information from that payment card (such as a payment account number [PAN], expiration date, security code) and attempt to use the payment card for purchases. As another example, a thief may steal information regarding a bank account, such as a bank account number and routing number, and attempt to use the bank account for purchases. These types of fraudulent transactions may be monitored by, for example, a fraud detection system within a payment network. Further, as used herein, a “suspected fraudulent transaction” is a payment transaction that is suspected to be fraudulent, but which has not yet been confirmed as fraudulent by, for example, the consumer of the underlying financial instrument (such as a payment card or bank account), or the issuing bank for a payment card, or the bank associated with a bank account, or an analyst associated with the fraud detection system.

As used herein, the term “real-time” is used, in some contexts, to refer to a regular updating of data within a system such as the purchase recommender systems, the instrument management systems, the wallet systems, fraud detections systems, and/or the displays described herein. When a system is described as processing or performing a particular operation “in real-time,” this may mean within seconds or minutes of an occurrence of some trigger event, such as new data being generated, or on some regular schedule, such as every minute. In other contexts, some payment card transactions require “real-time” recommendation operations, such as transmitting a modified payment request to a payment card interchange network. Real-time recommendation operations refers to operations performed during authorization of a payment card transaction (that is, between the moment that a new payment card transaction is initiated from, for example, a merchant, and the time that an authorization decision is made, for example, back to that merchant). In such a context, “near real-time” fraud operations are operations conducted shortly after the payment card transaction has occurred (that is, after an authorization decision is made).

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The following detailed description illustrates embodiments of the disclosure by way of example and not by way of limitation. It is contemplated that the disclosure has general application to management of financial instruments.

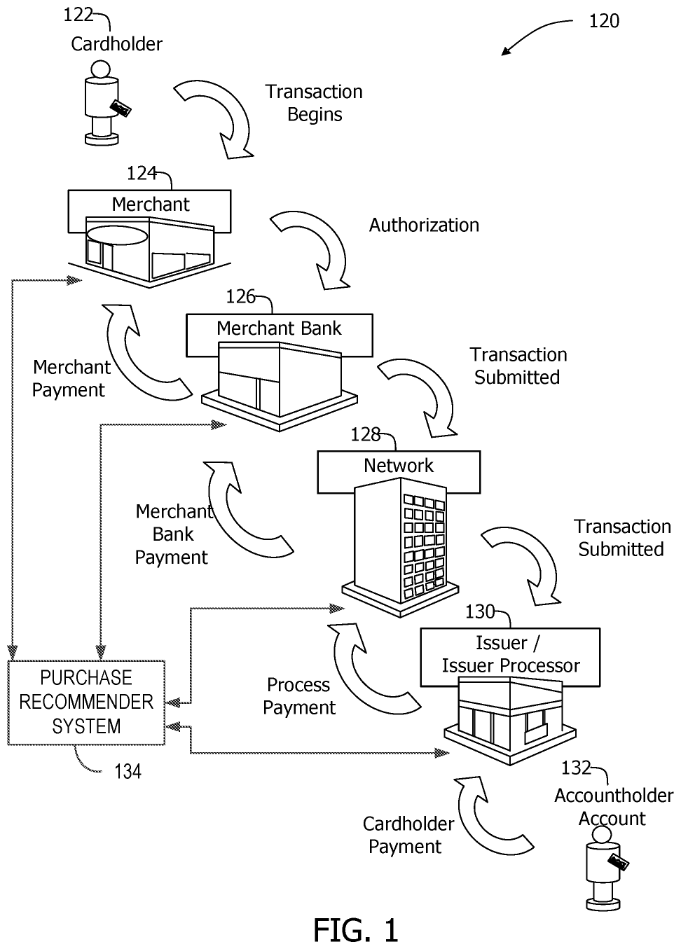

FIG. 1 is a schematic diagram illustrating a purchase recommender system 134 integrated with an example multi-party payment processing system 120 for enabling payment-by-card transactions in accordance with one embodiment of this disclosure. Embodiments described herein may relate to a payment card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

As described with respect to payment processing system 120 (also referred to herein as payment network 120), a financial institution called the “issuer” issues a payment card, such as a credit card, to a consumer or cardholder 122, who uses the payment card to tender payment for a purchase from a merchant 124. To accept payment with the payment card, merchant 124 must normally establish an account with a financial institution that is part of the financial payment system. This financial institution is usually called the “merchant bank,” the “acquiring bank,” or the “acquirer.” When cardholder 122 tenders payment for a purchase with a payment card, merchant 124 requests authorization from a merchant bank 126 for the amount of the purchase. The request may be performed over the telephone or online or by an in-person merchant manually typing in the payment card information into a computer system, but the request is frequently performed through the use of a point-of-sale (POS) terminal, which reads cardholder's 122 payment card information from a magnetic stripe, a chip, or embossed characters on the payment card and communicates electronically with the transaction processing computers of merchant bank 126. Alternatively, merchant bank 126 may authorize a third party to perform transaction processing on its behalf. In this case, the POS terminal will be configured to communicate with the third party. Such a third party is usually called a “merchant processor,” an “acquiring processor,” or a “third party processor.”

Using a payment card interchange network 128 (which is also referred to herein as payment processor 128 and payment processing network 128), computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

When a request for authorization is accepted, the available credit line of cardholder's 122 account 132 is decreased. Normally, a charge for a payment card transaction is not posted immediately to cardholder's 122 account 132 because payment card associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the POS terminal. This may include bundling of approved transactions daily for standard retail purchases. If cardholder 122 cancels a transaction before it is captured, a “void” is generated. If cardholder 122 returns goods after the transaction has been captured, a “credit” is generated. Payment card interchange network 128 and/or issuer bank 130 stores the payment card transaction information, such as a category of merchant, a merchant identifier, a location where the transaction occurred, amount of purchase, date and time of transaction, in a database 206.

After a purchase has been made, a clearing process occurs to transfer additional transaction data related to the purchase among the parties to the transaction, such as merchant bank 126, payment card interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 122 purchases travel, such as airfare, a hotel stay, and/or a rental car, at least partial itinerary information is transmitted during the clearance process as transaction data. When payment card interchange network 128 receives the itinerary information, payment card interchange network 128 routes the itinerary information to database 206.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, issuer bank 130, and an account merchant 124 related to the transaction. More specifically, a transaction is typically settled between issuer bank 130 and payment card interchange network 128, and then between payment card interchange network 128 and merchant bank 126, and then between merchant bank 126 and merchant 124. Usually, transactions are captured and accumulated into a “batch,” which is settled as a group.

Some transactions may be made using a virtual primary account number (VPAN). A VPAN allows the payment processing network to process payments from installment programs, rewards programs, promotion programs, net systems, and other non-payment-card electronic financial instruments by using a VPAN associated with the financial instrument. The VPAN may further be associated with a particular user profile and a particular user. Payment card interchange network 128 may be programmed to identify a particular user based on a VPAN.

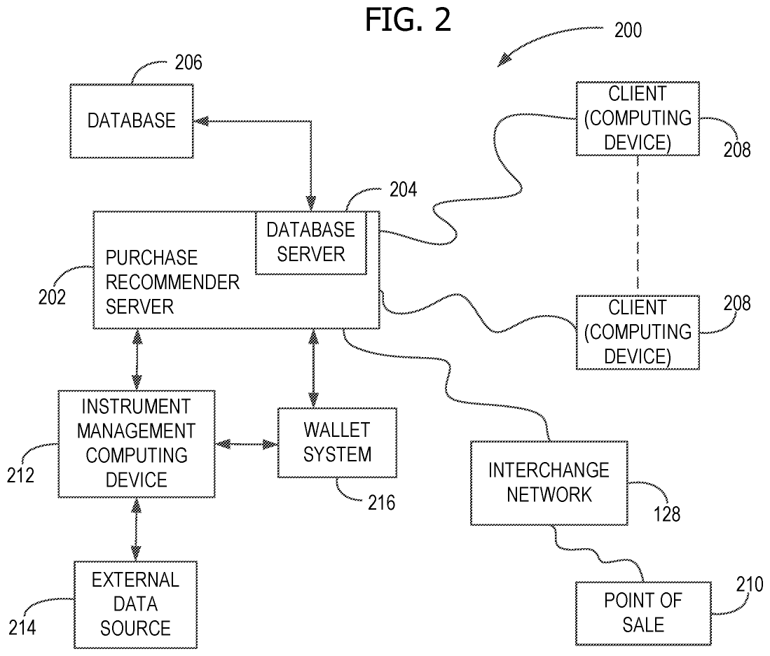

As described below in more detail, a purchase recommender system 134 may be used to analyze a plurality of financial instruments available to a cardholder for a transaction and recommend which financial instrument would be optimal for the cardholder to use. Purchase recommender system 134 includes a purchase recommender computing device (such as purchase recommender server system 202 shown in FIG. 2). Purchase recommender system 134 may also include an instrument management system (such as instrument management computing device 212 shown in FIG. 2) and a wallet system (such as wallet system 216 shown in FIG. 2). In the example embodiment, purchase recommender system 134 is associated with payment card interchange network 128. In other embodiments, purchase recommender system 134 may be associated with merchant 124, merchant bank 126, or issuer bank 130.

FIG. 2 is a simplified block diagram of an example system 200 used for recommending financial instruments in accordance with one example embodiment of the present disclosure. System 200 may be implemented in the performance of payment-by-card transactions received as part of processing cardholder transactions. In an example embodiment, system 200 is a payment processing system 120 (shown in FIG. 1) that includes a purchase recommender server system 202 programmed to recommend financial instruments, an instrument management computing device 212 programmed to manage financial instruments, and a wallet system 216 programmed to access purchase recommender server system 202 when making payment transactions.

In the example embodiment, system 200 includes a purchase recommender server system 202 and client systems 208. In some embodiments, client systems 208 include computers configured to implement a web browser or a software application, which enables client systems 208 to access purchase recommender server system 202 using the Internet. Client systems 208 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Alternatively, client systems 208 include any device capable of accessing the Internet including, but not limited to, a desktop computer, a laptop computer, a personal digital assistant (PDA), a cellular phone, a smartphone, a tablet, a phablet, or other web-based connectable equipment. In the example embodiment, client systems 208 may be computing devices associated with one of cardholder 122, merchant 124, merchant bank 126, and/or issuer bank 130.

In one embodiment, purchase recommender server system 202 includes a database server 204 that is communicatively coupled to a database 206 for storing data. In an exemplary embodiment, database 206 stores financial instrument data for a plurality of cardholders and users. According to the exemplary embodiment, database 206 is disposed remotely from purchase recommender server system 202. In other embodiments, database 206 is decentralized, or may be a portion of purchase recommender server system 202. In the exemplary embodiment, a user (not shown) is able to access database 206 through client systems 208 by logging onto purchase recommender server system 202. In the example embodiment, purchase recommender server system 202 may be associated with payment card interchange network 128.

System 200 further includes one or more POS systems 210 that are communicatively coupled with the purchase recommender server system 202. POS systems 210 may be, for example, merchants 124, and are communicatively coupled with purchase recommender server system 202 through payment network 120. POS systems 210 may include, without limitation, machines that accept card swipes, machines that accept chip card insertions, online payment portals, digital wallet payments, or stored payment card numbers for recurring transactions.

In the example embodiment, purchase recommender server system 202 is associated with a financial transaction interchange network, such as payment card interchange network 128, and is also referred to as an interchange computer system. In some embodiments, purchase recommender server system 202 is used for processing transaction data and identifying optimal financial instruments. In one embodiment, at least one of client systems 208 includes a computer system associated with a wallet system. Accordingly, purchase recommender server system 202 and client systems 208 may be used to process transaction data relating to purchases a cardholder makes using a financial instrument associated with wallet system 216 or using a VPAN associated with the wallet system 216. In the exemplary embodiment, at least one client system 208 may be associated with a user or a cardholder seeking to register, access information, or process a transaction with at least one of the interchange network, the issuer, or the merchant. In addition, client systems 208 or POS systems 210 may include individual POS devices (not shown) associated with a merchant and used for processing payment transactions. In an alternative embodiment, at least one client system 208 is utilized for reviewing available financial instruments.

In the example embodiment, instrument management computing device 212 is communicatively coupled with purchase recommender server system 202. Instrument management computing device 212 can access purchase recommender server system 202 to store and access data and to communicate with the client systems 208 through purchase recommender server system 202. In some embodiments, instrument management computing device 212 may be associated with or part of payment card interchange network 128, or in communication with payment network 120. In other embodiments, instrument management computing device 212 is associated with a third party and is in electronic communication with the payment network 120. In some embodiments, instrument management computing device 212 may be associated with, or be part of merchant bank 126, payment card interchange network 128, and issuer bank 130, all shown in FIG. 1.

In an example embodiment, instrument management computing device 212 is communicatively coupled to at least one external data source 214. External data source 214 may be a computer system maintained by a bank, merchant, merchant acquirer, issuer, payment card association, government agency, or another party with information helpful for analyzing financial instruments. Instrument management computing device 212 may retrieve information from at least one external data source 214 to help identify available financial instruments and related data (for example, interest rates, discounts, benefits, requirements, etc.). Instrument management computing device 212 may then, for example, use the identified available financial instruments to generate a financial instrument portfolio for a cardholder, the financial instrument portfolio including data regarding a plurality of financial instruments. In some embodiments, instrument management computing device 212 may also generate financial instrument portfolios for a user, merchant, merchant acquirer, issuer, payment card interchange network, etc.

In the example embodiment, wallet system 216 is communicatively coupled with purchase recommender server system 202. Wallet system 216 accesses purchase recommender server system 202 to store and access data and to communicate with the client systems 208 through purchase recommender server system 202. In some embodiments, wallet system 216 may be associated with or part of payment card interchange network 128, or in communication with payment network 120. In other embodiments, wallet system 216 is associated with a third party and is in electronic communication with the payment network 120. In some embodiments, wallet system 216 may be associated with, or be part of merchant bank 126, payment card interchange network 128, and issuer bank 130, all shown in FIG. 1.

In the example embodiment, purchase recommender server system 202 recommends financial instruments in real time for payment transactions in a payment processing network. Purchase recommender server system 202 receives, from payment card interchange network 128, a payment request for a payment transaction. The payment request includes a user identifier associated with a user profile for a user. The user identifier may be a virtual primary account number, as described in reference to FIG. 1. Purchase recommender server system 202 retrieves a financial instrument portfolio associated with the user profile based on the user identifier. The financial instrument portfolio includes data regarding a plurality of financial instruments available for the user to use in relation to the payment transaction. Purchase recommender server system 202 uses the financial instrument portfolio to determine a recommended financial instrument.

The financial instrument portfolio may be generated by instrument management computing device 212. In such embodiments, instrument management computing device 212 receives basic financial instrument data from the user from wallet system 216. The basic financial instrument data includes data regarding at least one financial instrument. The basic financial instrument data may, for example, include information necessary to identify and use a payment card, such as a PAN, expiration date, and/or security code. Or the basic financial instrument data may include simple information about a bank account, such as a bank account number and/or routing number.

Wallet system 216 receives, from the user, the basic financial instrument data. The user may enter the basic financial instrument data into the wallet system on a user computer device (such as a mobile computing device) that includes at least part of the wallet system or is communicatively coupled to wallet system 216. The wallet system may also prompt the user to consent to instrument management computing device 212 generating the financial instrument portfolio and storing the financial instrument portfolio in at least one location in memory. Wallet system 216 transmits the basic financial instrument data to instrument management computing device 212.

Instrument management computing device 212 gathers additional financial instrument data from at least one of a bank computer system, an issuer computer system, a payment card interchange network system, a merchant computer system, and an acquirer computer system. These systems from which the additional financial instrument data is gathered may be associated with one or more external data sources 214 or may be contained within payment card interchange network 128. The additional financial instrument data relates to at least one of the basic financial instrument data, the user, and a payment transaction associated with the user. Generally, the additional financial instrument data also relates to at least one of a bank account, a payment card, an installment program, a rewards program, and a promotion program. Installment programs, rewards programs, and promotion programs may be sponsored or funded by merchant 124, merchant acquirer 126, payment card interchange network 128, or issuer 130.

For example, the additional financial instrument data may include details about a financial instrument, such as a bank account, associated with the basic financial instrument data, and the details about the bank account may include a balance, an interest rate, an associated rewards program, a balance of rewards points, or an amount of rewards points that would be gained as a result of a payment transaction using the bank account. As another example, the additional financial instrument data may include an installment program offered by a merchant acquirer associated with a payment transaction, including details regarding that program, such as an annual percentage rate (APR), a number of installments, a minimum payment amount, a length of an installment period, etc. As yet another example, the additional financial instrument data may include a cash discount or cash back offered by a merchant associated with a payment transaction for payment transactions meeting certain requirements.

Instrument management computing device 212 may correlate the basic financial instrument data and additional financial instrument data with information from an external data source 214 to assist in the analysis.

Instrument management computing device 212 generates the financial instrument portfolio for the user based on the basic financial instrument data and the additional financial instrument data. The financial instrument portfolio includes data regarding a plurality of financial instruments. In one embodiment instrument management computing device 212 generates the financial instrument portfolio as a file (for example, an XML file, a JSON file, a CSV file). Instrument management computing device 212 may store the file in one or more locations in memory. In another embodiment, instrument management computing device 212 generates the financial instrument portfolio as a new row in a database table. Alternatively, instrument management computing device 212 may generate the financial instrument portfolio as an updated row in a database table. In yet another embodiment, instrument management computing device 212 generates the financial instrument portfolio as structured data (such as an array, a linked list, a hash table, an object, a map, a tree, a graph, etc.). In some embodiments, instrument management computing device 212 may also generate financial instrument portfolios for a user, merchant, merchant acquirer, issuer, payment card interchange network, etc.

When wallet system 216 initiates a payment transaction with a merchant computer system, purchase recommender server system 202 receives a payment request from payment card interchange network 128 regarding the payment transaction. Wallet system 216 may initiate the payment transaction based on interaction of a user computer device with a near field communication device, such as a first interaction of the user computer device with a POS terminal 210. As mentioned above, purchase recommender server system 202 also retrieves the financial instrument portfolio. Based on the payment request and the retrieved financial instrument portfolio, purchase recommender server system 202 determines a recommended financial instrument. Purchase recommender server system 202 may determine the recommended financial instrument based on at least one of: a net present value, user preferences associated with the user profile, a calculated fraud score, rewards points, an interest rate, a discount, and a machine learning algorithm.

Optionally, purchase recommender server system 202 may further determine multiple recommended financial instruments. The multiple recommended financial instruments may be ranked (for example, in a ranked list) by which financial instruments are most recommended by the purchase recommender computing device for completing the financial transaction. Alternatively, the multiple recommended financial instruments may be categorized, such as by indicating which financial instrument would achieve the highest net present value for the payment transaction, which financial instrument would obtain the most rewards points for the payment transaction, and which financial instrument has the lowest calculated fraud score for the payment transaction.

Purchase recommender server system 202 determines a final financial instrument based on the recommended financial instrument. In one embodiment, purchase recommender server system 202 determines the final financial instrument to be the recommended financial instrument.

In the example embodiment, purchase recommender server system 202 determines the final financial instrument by transmitting the recommended financial instrument to wallet system 216, which receives the recommended financial instrument. Wallet system 216 instructs a user computer device to display the received recommended financial instrument. Wallet system 216 also instructs the user computer device to prompt the user to either confirm that the recommended financial instrument be used as a selected financial instrument (that is, approve the recommended financial instrument) or select another financial instrument to be used as the selected financial instrument.

Wallet system 216 receives, from the user, via the user computer device, as a response to the prompt, the selected financial instrument. Wallet system 216 may receive the selected financial instrument from the user based on interaction of the user computer device with a near field communication device, such as a second interaction of the user computer device with a POS terminal 210. In the example embodiment, wallet system 216 receives a second near field communication interaction with a POS terminal 210 as an approval of the recommended financial instrument. Wallet system 216 then transmits the selected financial instrument to purchase recommender server system 202. Purchase recommender server system 202 receives the selected financial instrument from wallet system 216. Purchase recommender server system 202 then determines the final financial instrument to be the selected financial instrument.

Purchase recommender server system 202 transmits, in real time, a modified payment request for the payment transaction to payment card interchange network 128. The modified payment request includes the final financial instrument.

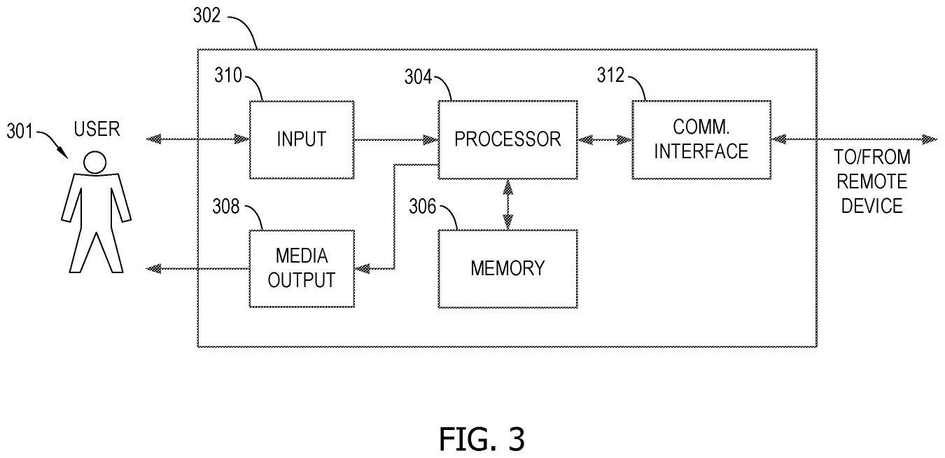

FIG. 3 illustrates an example configuration of a client system 300 in accordance with one embodiment of the present disclosure. In the example embodiment, client system 300 includes at least one user computer device 302, operated by a user 301. User computer device 302 may be representative of, but is not limited to, one or more of client systems 208, instrument management computing device 212, and wallet system 216 (all shown in FIG. 2). User computer device 302 includes a processor 304 for executing instructions, and a memory area 306. In some embodiments, executable instructions are stored in memory area 306. Processor 304 may, for example, include one or more processing units (for example, in a multi-core configuration). Memory area 306 may, for example, be any device allowing information such as executable instructions and/or transaction data to be stored and retrieved. Memory area 306 may further include one or more computer readable media.

In the example embodiment, user computer device 302 further includes at least one media output component 308 for presenting information to user 301. Media output component 308 may, for example, be any component capable of converting and conveying electronic information to user 301. In some embodiments, media output component 308 includes an output adapter (not shown), such as a video adapter and/or an audio adapter, which is operatively coupled to processor 304 and operatively coupleable to an output device (also not shown), such as a display device (for example, a cathode ray tube [CRT], liquid crystal display [LCD], light emitting diode [LED] display, or “electronic ink” display) or an audio output device (for example, a speaker or headphones).

In some embodiments, media output component 308 is configured to include and present a graphical user interface (not shown), such as a web browser and/or a client application, to user 301. The graphical user interface may include, for example, an online store interface for viewing and/or purchasing items, and/or a wallet application for managing payment information as part of a wallet system. In some embodiments, user computer device 302 includes an input device 310 for receiving input from user 301. User 301 may use input device 310, without limitation, to select or enter one or more items to purchase or request to purchase, to access credential information, or to access payment information. Input device 310 may include, for example, a keyboard, a pointing device, a mouse, a stylus, a touch sensitive panel (such as a touch pad or a touch screen), a gyroscope, an accelerometer, a position detector, a biometric input device, or an audio input device. A single component such as a touch screen may function as both an output device of media output component 308 and input device 310.

In one embodiment, user computer device 302 further includes a communication interface 312, communicatively coupled to a remote device such as purchase recommender server system 202. Communication interface 312 may include, for example, a wired or wireless network adapter and/or a wireless data transceiver for use with a mobile telecommunications network.

In the example embodiment, memory area 306 stores computer readable instructions for providing a user interface to user 301 through media output component 308 and, optionally, for receiving and processing input from input device 310. A user interface may include, among other possibilities, a web browser and/or a client application. Web browsers enable users, such as user 301, to display and interact with media and other information typically embedded on a web page or a website from purchase recommender server system 202. A client application allows user 301 to interact with, for example, purchase recommender server system 202. In one example, instructions may be stored by a cloud service, and the output of the execution of the instructions sent to the media output component 308.

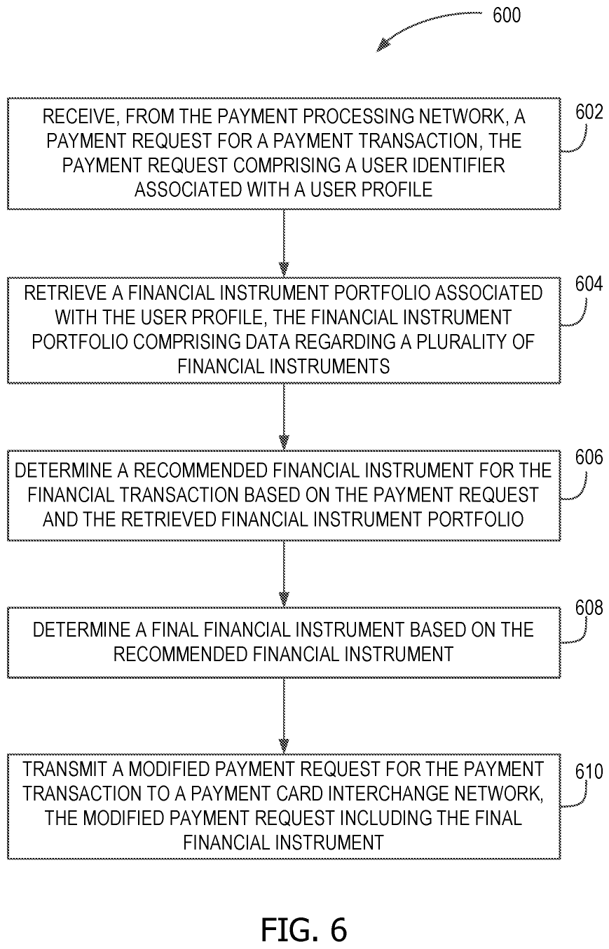

Processor 304 executes computer-executable instructions for implementing aspects of the disclosure. In some embodiments, processor 304 is transformed into a special purpose microprocessor by executing computer-executable instructions or by otherwise being programmed. For example, processor 304 may be programmed with instructions such that it may execute the processes as illustrated in FIGS. 6, 7, and 8, below.

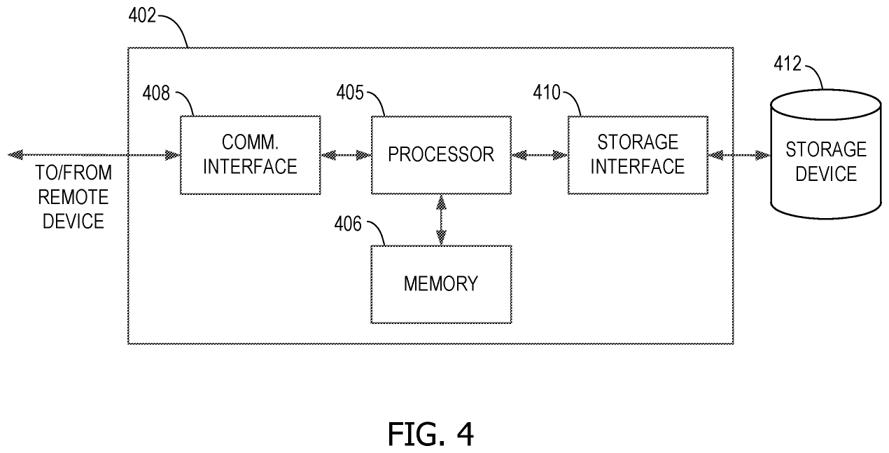

FIG. 4 illustrates an example configuration of a server system 400, in accordance with an embodiment of the present disclosure. In the example embodiment, server system 400 includes at least one server computer device 402, in electronic communication with at least one storage device 412. Server computer device 402 may be representative of, but is not limited to, one or more of purchase recommender server system 202, database server 204, instrument management computing device 212, and wallet system 216 (all shown in FIG. 2). In the exemplary embodiment, server computer device 402 includes a processor 405 for executing instructions (not shown) stored in a memory area 406. In an embodiment, processor 405 may include one or more processing units (for example, in a multi-core configuration). The instructions may be executed within various different operating systems on the server computer device 402, such as UNIX®, LINUX® (LINUX is a registered trademark of Linus Torvalds), Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (for example, C, C #, C++, Java, or other suitable programming languages, etc.).

In the example embodiment, processor 405 is operatively coupled to a communication interface 408 such that server system 400 is capable of communicating with a remote device such as a user system or another server system 400. For example, communication interface 408 may receive requests from client system 300 (FIG. 3) via the Internet, within the scope of the embodiment illustrated in FIG. 4.

In the example embodiment, processor 405 is also operatively coupled to a storage device 412, which may be, for example, a computer-operated hardware unit suitable for storing and/or retrieving data. In some embodiments, storage device 412 is integrated in server system 400. For example, server system 400 may include one or more hard disk drives as storage device 412. In other embodiments, storage device 412 is external to server system 400 and may be accessed by a plurality of server systems 400. For example, storage device 412 may include multiple storage units such as hard disks or solid state disks in a redundant array of inexpensive disks (RAID) configuration. Storage device 412 may include a storage area network (SAN) and/or a network attached storage (NAS) system.

In some embodiments, processor 405 is operatively coupled to storage device 412 via an optional storage interface 410. Storage interface 410 may include, for example, a component capable of providing processor 405 with access to storage device 412. In an exemplary embodiment, storage interface 410 further includes one or more of an Advanced Technology Attachment (ATA) adapter, a Serial ATA (SATA) adapter, a Small Computer System Interface (SCSI) adapter, a RAID controller, a SAN adapter, a network adapter, and/or a similarly capable component providing processor 405 with access to storage device 412.

Memory area 406 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program.

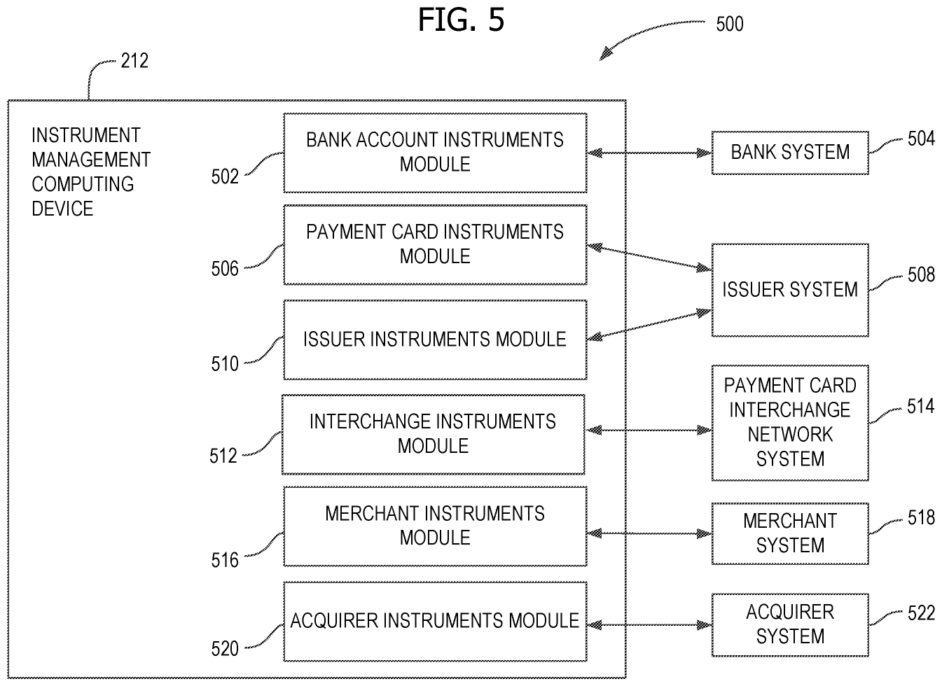

FIG. 5 shows an example configuration 500 of an instrument management computing device 212, in accordance with one embodiment of the present disclosure. Instrument management computing device 212 receives basic financial instrument data for the user from a wallet system, the basic financial instrument data including data regarding at least one financial instrument. The basic financial instrument data may, for example, include information necessary to identify and use a payment card, such as a PAN, expiration date, and/or security code. Or the basic financial instrument data may include simple information about a bank account, such as a bank account number and/or routing number.

In this embodiment, instrument management computing device 212 includes several modules. The modules are each programmed to gather additional financial instrument data from various systems. The additional financial instrument data relates to at least one of the basic financial instrument data, the user, and a payment transaction associated with the user. Generally, the additional financial instrument data also relates to at least one of a bank account, a payment card, an installment program, a rewards program, and a promotion program. Installment programs, rewards programs, and promotion programs may be sponsored or funded by merchant 124, merchant acquirer 126, payment card interchange network 128, or issuer 130.

For example, the additional financial instrument data may include details about a financial instrument, such as a bank account, associated with the basic financial instrument data, and the details about the bank account may include a balance, an interest rate, an associated rewards program, a balance of rewards points, or an amount of rewards points that would be gained as a result of a payment transaction using the bank account. As another example, the additional financial instrument data may include an installment program offered by a merchant acquirer associated with a payment transaction, including details regarding that program, such as an annual percentage rate (APR), a number of installments, a minimum payment amount, a length of an installment period, etc. As yet another example, the additional financial instrument data may include a cash discount or cash back offered by a merchant associated with a payment transaction for payment transactions meeting certain requirements.

The modules or instrument management computing device 212 may correlate the basic financial instrument data and additional financial instrument data with information from an external data source 214 to assist in the analysis.

In the example embodiment, a bank accounts instruments module 502 is programmed to gather, from at least one bank computer system 504, additional financial instrument data regarding bank accounts associated with the user profile. Bank computer system 504 may be associated one or more of cardholder's 122 accounts 132.

A payment card instruments module 506 is programmed to gather, from at least one issuer computer system 508, additional financial instrument data regarding payment cards associated with the user profile. Issuer computer system 508 may be associated with issuer bank 130.

An issuer instruments module 510 is also programmed to gather additional financial instrument data from at least one issuer computer system 508, but the data that issuer instruments module 510 is programmed to gather is associated with at least one issuer associated with the user profile and regards at least one of an installment program, a rewards program, and a promotion program.

An interchange instruments module 512 is programmed to gather, from at least one payment card interchange network system 514, additional financial instrument data associated with at least one payment card interchange network associated with the user profile, the additional financial instrument data regarding at least one of an installment program, a rewards program, and a promotion program. Payment card interchange network system 514 may be associated with payment card interchange network 128.

In some embodiments, the payment request may include a merchant identifier representing a merchant. In such an embodiment, instrument management computing device 212 may include a merchant instruments module 516 and an acquirer instruments module 520. Merchant instruments module 516 is programmed to gather, from at least one merchant computer system 518, additional financial instrument data associated with the merchant, the additional financial instrument data regarding at least one of an installment program, a rewards program, and a promotion program. Merchant computer system 518 may be associated with merchant 124.

Acquirer instruments module 520 is programmed to gather, from at least one acquirer computer system 522, additional financial instrument data associated with an acquirer associated with the merchant, the additional financial instrument data regarding at least one of an installment program, a rewards program, and a promotion program. Acquirer computer system 522 may be associated with merchant bank 126.

Instrument management computing device 212 is programmed to use the additional financial instrument data gathered by these modules along with the basic financial instrument data to generate a financial instrument portfolio. The financial instrument portfolio is based on the basic financial instrument data and the additional financial instrument data. Accordingly, the financial instrument portfolio includes data regarding a plurality of financial instruments.

FIG. 6 is a flowchart of a computer-implemented method 600 for recommending financial instruments using a purchase recommender computing device (for example, purchase recommender server system 202) in communication with a payment processing network (for example, payment network 120), which may be implemented using system 200. In the example embodiment, method 600 begins at step 602, where purchase recommender server system 202 receives, from payment network 120, a payment request for a payment transaction. The payment request includes a user identifier associated with a user profile for a user. The user identifier may be a virtual primary account number as described in reference to FIG. 1. The payment request further includes a merchant identifier associated with a merchant 124.

In step 604, purchase recommender server system 202 retrieves a financial instrument portfolio associated with the user profile based on the user identifier. The financial instrument portfolio includes data regarding a plurality of financial instruments available for the user to use in relation to the payment transaction.

In step 606, purchase recommender server system 202 determines a recommended financial instrument for the payment transaction based on the payment request and the retrieved financial instrument portfolio. Purchase recommender server system may determine the recommended financial instrument based on at least one of: a net present value, user preferences associated with the user profile, a calculated fraud score, rewards points, an interest rate, a discount, and a machine learning algorithm.

When purchase recommender server system 202 determines the recommended financial instrument, it may base the determination on one or more measures by prioritizing or weighting financial instruments based on the one or more measures. The one or more measures may include one or more rules and/or thresholds against which the financial instruments are compared. In some embodiments, purchase recommender server system 202 prioritizes financial instruments based on a first measure by breaking down the first measure into tiers (for example, a high tier, a medium tier, and a low tier based on threshold values and/or rankings related to the first measure), and then considering values in a first tier unless no values exist in that tier, and then purchase recommender server system 202 considers values in the next tier. Purchase recommender server system 202 ranks the financial instruments within the tier considered by a second measure and then recommends the financial instrument within the tier considered that has the highest rank based on the second measure. Although in this case purchase recommender server system 202 determines the recommended financial instrument based on the second measure, the financial instruments are first prioritized based on the first measure, so the determination is based on both the first and second measures.

In other embodiments, purchase recommender server system 202 weights the financial instruments based on a plurality of measures by first normalizing each of the measures within the plurality of measures to be on a comparable scale (such as by converting all measures to a 0 to 100 scale, with 100 being the most desirable value and 0 being the least desirable value) to produce a plurality of normalized measures. For each of the plurality of normalized measures, purchase recommender server system 202 uses a respective weighting coefficient representing the weight to be given to the respective normalized measure. The respective weighting coefficients may be retrieved from a user preference, the output of a machine learning algorithm (as discussed more below), or a system default. After normalizing the values, purchase recommender server system 202 multiplies, for each financial instrument, each of the plurality of normalized measures for the financial instrument by the respective weighting coefficient to produce a plurality of weighted measures. Purchase recommender server system 202 then adds the plurality of weighted measures together to produce a weighted sum for each financial instrument. Purchase recommender server system 202 then determines the recommended financial instrument based on the corresponding weighted sums. In one embodiment, purchase recommender server system 202 determines the recommended financial instrument to be the financial instrument with the highest weighted sum. In this way, the determination is based on a plurality of measures.

In some embodiments, purchase recommender server system 202 determines the recommended financial instrument by combining prioritizing and weighting by using a weighted sum or weighted sums as the first measure and/or second measure when prioritizing. In other embodiments, purchase recommender server system 202 determines the recommended financial instrument based on a single measure.

A calculated fraud score may be calculated by a fraud detection system, the calculated fraud score representing the likelihood of theft of information regarding a financial instrument if that financial instrument is used to complete the payment transaction. Calculated fraud scores may be based on historical transaction data, such as fraudulent transactions or suspected fraudulent transactions at a merchant 124, at merchants of a similar category, through a merchant bank 126, through a payment card interchange network 128, through a particular issuer 130, with a particular type of financial instrument, etc. In one embodiment, purchase recommender server system 202 receives calculated fraud scores for the payment transaction for each financial instrument represented in the financial instrument portfolio from a fraud detection system associated with payment card interchange network 128. As with other measures, purchase recommender server system 202 may be programmed to prioritize or weight financial instruments based on the calculated fraud scores.

Prioritizing or weighting financial instruments based on calculated fraud scores may help prevent fraud by avoiding use of a financial instrument in situations where the risk of theft of information regarding the financial instrument is high. For example, purchase recommender server system 202 may prioritize financial instruments with a calculated fraud score within a first tier of calculated fraud scores (for example, a range of low scores indicating a low probability of theft of information regarding a financial instrument) over financial instruments with a calculated fraud score within a second tier of calculated fraud scores (for example, a range of high scores indicating a high probability of theft of information regarding a financial instrument)

Net present value considers the financial benefit accrued through each financial instrument. Basing the determination of the recommended financial instrument on net present value may result in the purchase recommender computing device determining the recommended financial instrument to be the financial instrument that maximizes monetary value to the user. In some embodiments, net present value may be calculated as the difference between the present value of cash inflows and the present value of cash outflows over a period of time. For a simple example, if the user has a bank account with an APR or APY of 5%, the net present value of a cash payment (a cash outflow) of $105 to be made a year from now (for example, as a payment on an installment plan) may be negative $100 because $100 stored into the bank account today a would become $105 a year from now because of interest. As another simple example, consider a credit card payment (a cash outflow) of $100 made today by the same user using a credit card where no payment on the $100 credit card balance needs to be made for one year, but then the $100 must be paid off, and where the $100 would generate 10% interest over that year. The interest generated would be $10, meaning $110 must be paid off at the end of the year, so the net present value of the credit card payment may be negative $104.76 because $104.76 stored into the bank account today would become $110 a year from now because of interest. Therefore, the cash payment of $105 a year from now (with a net present value of negative $100, indicating a $100 loss) will cost the user less in the long term than the credit card payment of $100 today (with a net present value of negative $104.76, indicating a $104.76 loss).

Purchase recommender server system 202 may be programmed to consider not only scenarios where the user makes minimum payments (for example, on an installment plan or credit card balance), but also scenarios where the user pays the balance off all at once (for example, the day before any interest is generated or two weeks before any interest is generated). Purchase recommender server system 202 may treat these different scenarios as different financial instruments even though both scenarios would use the same financial instrument. Purchase recommender server system 202 may also be programmed to send reminders to the user of upcoming payments (for example, as an email, as an SMS message, or as an application notification).

User preferences associated with the user profile may indicate what priority or weight to give to each factor. For example, the user may indicate that the user wishes to give priority or a higher weight to maximizing rewards points, and purchase recommender server system 202 may be programmed to change operation based on this preference by using rewards points that would be generated by a purchase as the first measure when prioritizing, by increasing the respective weighting coefficient for maximizing rewards points, and/or by decreasing other weighting coefficients. If the user indicates that the user wishes to give no weight to a measure, purchase recommender server system 202 may cease to use the indicated measure in a prioritization scheme, if applicable, and/or change the respective weighting coefficient for the indicated measure to zero.

Reward points that would be spent or generated by different rewards programs for the same purchase may be normalized in order to allow comparison between them. In one embodiment, rewards points are normalized to a scale from 0 to 1000, with 1000 being the maximum amount of rewards points that can be generated and 0 being no rewards points generated. In another embodiment, rewards points are normalized using an approximate cash value based on the amount of rewards points needed to receive a discount, cash back, or item worth a particular amount. The approximate cash value may be based on an average ratio of rewards points to cash value considering multiple available discounts, cash back opportunities, or items.

In embodiments where rewards points are normalized to an approximate cash value, the normalized rewards points may be combined with net present value to produce a hybrid measure. To calculate this hybrid measure, the approximate cash value of the rewards points that would be generated by a purchase may be added to the net present value, and the approximate cash value of the rewards points that would be spent on a purchase may be subtracted from the net present value.

Discounts and interest rates may be considered separately from other measures or combined with net present value to produce a hybrid measure, taking into account how discounts and interest rates affect the present values of cash inflows and cash outflows.

Machine learning algorithms may be used to improve the performance of purchase recommender server system 202. Machine learning algorithms may be used to determine user preferences based on one or more users' patterns regarding which financial instruments the one or more users have historically used for various kinds of purchases. Machine learning algorithms may be used to determine which recommendation schemes financially benefit users the most over time in actual practice. Machine learning algorithms may be used to determine calculated fraud scores based on historical patterns of fraud involving financial instruments. Machine learning algorithms may calculate which measures to consider, the values of the weighting coefficients for a plurality of measures, which measures to give priority to, and other rules that may be helpful in recommending financial instruments.

Optionally, purchase recommender server system 202 may also determine multiple recommended financial instruments. The multiple recommended financial instruments may be ranked (for example, in a ranked list) by which financial instruments are most recommended by purchase recommender server system 202 for completing the financial transaction. Alternatively, the multiple recommended financial instruments may be categorized, such as by indicating which financial instrument would achieve the highest net present value for the payment transaction, which financial instrument would obtain the most rewards points for the payment transaction, and which financial instrument has the lowest calculated fraud score for the payment transaction.

In step 608, purchase recommender server system 202 determines a final financial instrument based on the recommended financial instrument. In one embodiment, purchase recommender server system 202 determines the final financial instrument to be the recommended financial instrument. In the example embodiment, purchase recommender server system 202 transmits the recommended financial instrument to a user computer device, receives a selected financial instrument (such as an approval of the recommended financial instrument) from the user computer device, and determines the final financial instrument to be the selected financial instrument (which, in the case of an approval, is the approved recommended financial instrument).

In step 610, purchase recommender server system 202 transmits a modified payment request for the payment transaction to a payment card interchange network. The modified payment request includes the final financial instrument.

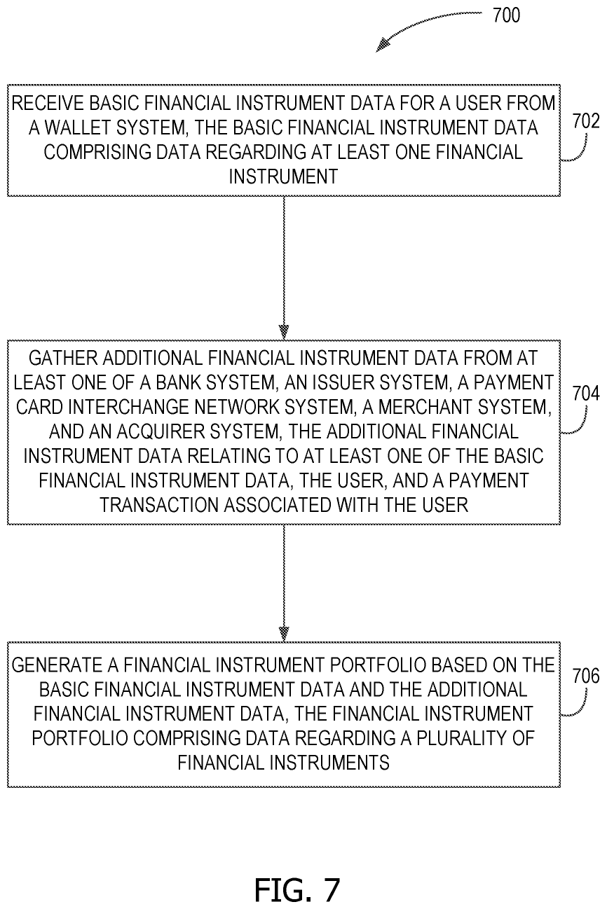

FIG. 7 is a flowchart of a computer-implemented method for managing financial instruments using an instrument management system (for example, instrument management computing device 212) in a payment card transaction network. In the example embodiment, method 700 begins at step 702, where instrument management computing device 212 receives basic financial instrument data for the user from a wallet system. The basic financial instrument data includes data regarding at least one financial instrument. The basic financial instrument data may, for example, include information necessary to identify and use a payment card, such as a PAN, expiration date, and/or security code. Or the basic financial instrument data may include simple information about a bank account, such as a bank account number and/or routing number.

In step 704, instrument management computing device 212 gathers additional financial instrument data from at least one of a bank computer system 504, an issuer computer system 508, a payment card interchange network system 514, a merchant computer system 518, and an acquirer computer system 522. The additional financial instrument data relates to at least one of the basic financial instrument data, the user, and a payment transaction associated with the user. Generally, the additional financial instrument data also relates to at least one of a bank account, a payment card, an installment program, a rewards program, and a promotion program. Installment programs, rewards programs, and promotion programs may be sponsored or funded by merchant 124, merchant acquirer 126, payment card interchange network 128, or issuer 130.

For example, the additional financial instrument data may include details about a financial instrument, such as a bank account, associated with the basic financial instrument data, and the details about the bank account may include a balance, an interest rate, an associated rewards program, a balance of rewards points, or an amount of rewards points that would be gained as a result of a payment transaction using the bank account. As another example, the additional financial instrument data may include an installment program offered by a merchant acquirer associated with a payment transaction, including details regarding that program, such as an annual percentage rate (APR), a number of installments, a minimum payment amount, a length of an installment period, etc. As yet another example, the additional financial instrument data may include a cash discount or cash back offered by a merchant associated with a payment transaction for payment transactions meeting certain requirements.

Instrument management computing device 212 may correlate the basic financial instrument data and additional financial instrument data with information from an external data source 214 to assist in the analysis.

In step 706, instrument management computing device 212 generates a financial instrument portfolio based on the basic financial instrument data and the additional financial instrument data. The financial instrument portfolio includes data regarding a plurality of financial instruments. The plurality of financial instruments may be the same plurality of financial instruments as in step 604.

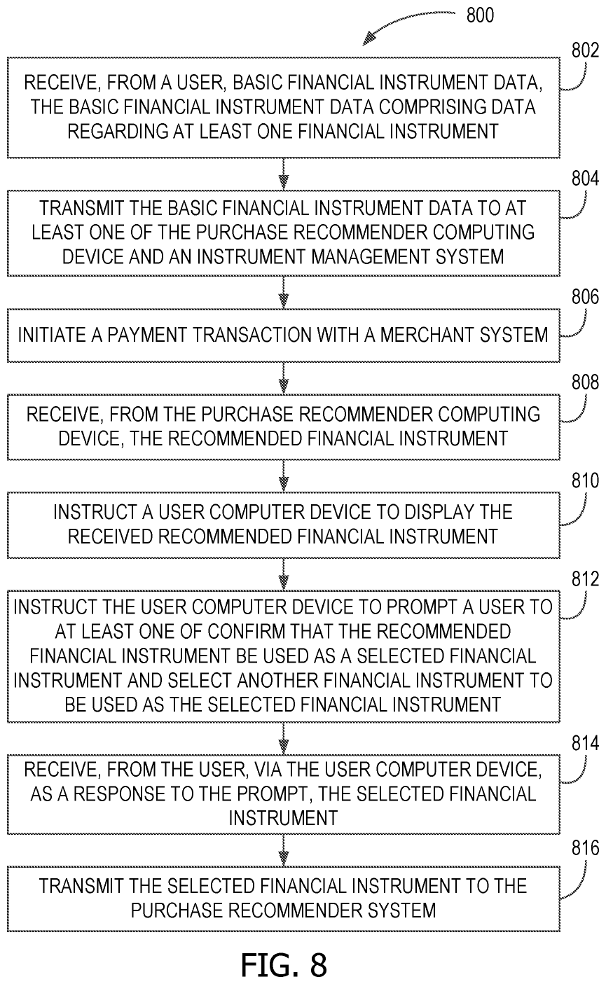

FIG. 8 is a flowchart of a computer-implemented method for accessing and using a purchase recommender computing device (for example, purchase recommender server system 202) through a wallet system (for example, wallet system 216) in a payment card transaction network. In the example embodiment, method 800 begins at step 802, where wallet system 216 receives, from the user, basic financial instrument data. The basic financial instrument data includes data regarding at least one financial instrument and may be the same basic financial instrument data as in step 702. Optionally, wallet system 216 may instruct a user computer device to prompt the user to consent to an instrument management system generating a financial instrument portfolio (for example, the financial instrument portfolio in steps 604 and 706) and storing the financial instrument portfolio in at least one location in memory.

In step 804, wallet system 216 transmits the basic financial instrument data to at least one of purchase recommender server system 202 and an instrument management system (for example, instrument management computing device 212). In step 806, wallet system 216 initiates a payment transaction with a merchant computer system. The payment transaction may be the same payment transaction as in steps 602, 606, and 610. Wallet system 216 may initiate the payment transaction based on interaction of a user computer device with a near field communication device, such as a first interaction of the user computer device with a POS terminal 210.

In step 808, wallet system 216 receives, from purchase recommender server system 202, the recommended financial instrument. In step 810, wallet system 216 instructs a user computer device to display the received recommended financial instrument. In step 812, wallet system 216 instructs the user computer device to prompt the user to either confirm that the recommended financial instrument be used as a selected financial instrument (that is, approve the recommended financial instrument) or select another financial instrument to be used as the selected financial instrument. In step 814, wallet system 216 receives, from the user, via the user computer device, as a response to the prompt in step 812, the selected financial instrument. Wallet system 216 may receive the selected financial instrument from the user based on interaction of the user computer device with a near field communication device, such as a second interaction of the user computer device with a POS terminal 210. In the example embodiment, wallet system 216 receives a second near field communication interaction with a POS terminal 210 as an approval of the recommended financial instrument. In step 816, wallet system 216 transmits the selected financial instrument (such as an approval of the recommended financial instrument) to purchase recommender server system 202.

Example embodiments of systems and methods for recommending financial instruments are described above in detail. Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

For example, the methods may also be used in combination with other recommendation systems and methods, and are not limited to practice with only the financial instrument recommendation systems and methods as described herein. Rather, the example embodiment can be implemented and utilized in connection with many other data storage and analysis applications. While the disclosure has been described in terms of various specific embodiments, those skilled in the art will recognize that particular elements of one drawing in the disclosure can be practice with elements of other drawings herein, or with modification thereto, and without departing from the spirit and/or scope of the claims.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product (that is, an article of manufacture) according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, such as “computing device,” are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, such as “cloud computing devices” and “cloud services,” refer to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

This written description uses examples to disclose the invention, including the best mode, and also to enable any person skilled in the art to practice the embodiments, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A purchase recommender computer system for recommending financial instruments in a payment processing network, said purchase recommender computer system comprising a purchase recommender computing device comprising at least one processor in communication with at least one memory, said purchase recommender computing device in communication with a payment processing network, an instrument management computing device, and a wallet system, said at least one processor programmed to:
receive, from the payment processing network, a payment request for a payment transaction, the payment request comprising a user identifier associated with a user profile for a user, wherein the payment request is generated in response to the wallet system initiating the payment transaction with a merchant computer system;
retrieve, from the instrument management computing device, a financial instrument portfolio associated with the user profile based on the user identifier, the financial instrument portfolio comprising data regarding a plurality of financial instruments available for the user to use in relation to the payment transaction;
compute a first measure and a second measure for each of the plurality of financial instruments based on the payment request and the retrieved financial instrument portfolio;
determine, for each of the plurality of financial instruments, a tier of a plurality of tiers based on the first measure;
determine a rank for each of a plurality of candidate financial instruments of the plurality of financial instruments that correspond to a first tier of the plurality of tiers according to the second measure;
determine a recommended financial instrument for the payment transaction by selecting a candidate financial instrument from the first tier based on the determined rank;
determine a final financial instrument based on the recommended financial instrument;
generate a modified payment request by updating the payment request to include the final financial instrument; and
transmit the modified payment request for the payment transaction to the payment processing network.

2. (canceled)

3. The purchase recommender computer system of claim 1, wherein the at least one processor is further programmed to:
transmit the recommended financial instrument to a user computer device; and
receive approval of the recommended financial instrument from the user computer device; and
determine the final financial instrument to be the approved recommended financial instrument.

4. The purchase recommender computer system of claim 1, further comprising the instrument management computing device, wherein the instrument management computing device is programmed to:
receive basic financial instrument data for the user from the wallet system, the basic financial instrument data comprising data regarding at least one financial instrument;
gather additional financial instrument data from at least one of a bank computer system, an issuer computer system, a payment card interchange network system, the merchant computer system, and an acquirer computer system, the additional financial instrument data relating to at least one of the basic financial instrument data, the user, and a payment transaction associated with the user; and
generate the financial instrument portfolio for the user based on the basic financial instrument data and the additional financial instrument data, the financial instrument portfolio comprising data regarding the plurality of financial instruments.

5. The purchase recommender computer system of claim 4, wherein the instrument management computing device comprises at least one of:
a bank account instruments module programmed to gather, from at least one bank computer system, additional financial instrument data regarding bank accounts associated with the user profile;
a payment card instruments module programmed to gather, from at least one issuer computer system, additional financial instrument data regarding payment cards associated with the user profile;
an issuer instruments module programmed to gather, from at least one issuer computer system, additional financial instrument data associated with an issuer associated with the user profile, the additional financial instrument data regarding at least one of an installment program, a rewards program, and a promotion program; and
an interchange instruments module programmed to gather, from at least one payment card interchange network system, additional financial instrument data associated with a payment card interchange network associated with the user profile, the additional financial instrument data regarding at least one of an installment program, a rewards program, and a promotion program.

6. The purchase recommender computer system of claim 4, wherein the payment request further comprises a merchant identifier representing a merchant, and wherein the instrument management computing device comprises at least one of:
a merchant instruments module programmed to gather, from the merchant computer system, additional financial instrument data associated with the merchant, the additional financial instrument data regarding at least one of an installment program, a rewards program, and a promotion program; and
an acquirer instruments module programmed to gather, from at least one acquirer computer system, additional financial instrument data associated with an acquirer associated with the merchant, the additional financial instrument data regarding at least one of an installment program, a rewards program, and a promotion program.

7. The purchase recommender computer system of claim 1, further comprising the wallet system, wherein the wallet system is programmed to:
receive, from the user, basic financial instrument data, the basic financial instrument data comprising data regarding at least one financial instrument;
transmit the basic financial instrument data to at least one of the purchase recommender computing device and the instrument management system; and
initiate the payment transaction with a merchant computer system.

8. The purchase recommender computer system of claim 7, wherein the wallet system is further programmed to:
receive, from the purchase recommender computing device, the recommended financial instrument;
instruct a user computer device to display the received recommended financial instrument;
instruct the user computer device to prompt the user to at least one of confirm that the recommended financial instrument be used as the final financial instrument and select another financial instrument to be used as the final financial instrument;
receive, from the user, via the user computer device, as a response to the prompt, the final financial instrument; and
transmit the final financial instrument to the purchase recommender computing device.

9. The purchase recommender computer system of claim 8, wherein the wallet system is programmed to receive the final financial instrument from the user based on interaction of the user computer device with a near field communication device.

10. The purchase recommender computer system of claim 1,
wherein the at least one processor is further programmed to determine the recommended financial instrument based on at least one of: a net present value, user preferences associated with the user profile, a calculated fraud score, rewards points, an interest rate, a discount, and a machine learning algorithm.

11. The purchase recommender computer system of claim 1, wherein the user identifier is a virtual primary account number.

12. A computer-implemented method for recommending financial instruments, said method implemented by a purchase recommender computer system comprising a purchase recommender computing device having at least one processor in communication with at least one memory, and a display device, the purchase recommender computing device in communication with a payment processing network, an instrument management computing device, and a wallet system, said method comprising:
receiving, by the purchase recommender computing device, from the payment processing network, a payment request for a payment transaction, the payment request comprising a user identifier associated with a user profile for a user, wherein the payment request is generated in response to the wallet system initiating the payment transaction with a merchant computer system;
retrieving, from the instrument management computing device, by the purchase recommender computing device, a financial instrument portfolio associated with the user profile based on the user identifier, the financial instrument portfolio comprising data regarding a plurality of financial instruments available for the user to use in relation to the payment transaction;
computing, by the purchase recommender computing device, a first measure and a second measure for each of the plurality of financial instruments based on the payment request and the retrieved financial instrument portfolio;
determining, by the purchase recommender computing device, for each of the plurality of financial instruments, a tier of a plurality of tiers based on the first measure;
determining, by the purchase recommender computing device, a rank for each of a plurality of candidate financial instruments of the plurality of financial instruments that correspond to a first tier of the plurality of tiers according to the second measure;
determining, by the purchase recommender computing device, a recommended financial instrument for the payment transaction by selecting a candidate financial instrument from the first tier based on the determined rank;
determining, by the purchase recommender computing device, a final financial instrument based on the recommended financial instrument;
generating, by the purchase recommender computing device, a modified payment request by updating the payment request to include the final financial instrument; and
transmitting, by the purchase recommender computing device, the modified payment request for the payment transaction to the payment processing network.

13. (canceled)

14. The computer-implemented method of claim 12, further comprising the steps of:
transmitting, by the purchase recommender computing device, the recommended financial instrument to a user computer device; and
receiving, by the purchase recommender computing device, approval of the recommended financial instrument from the user computer device; and
determining, by the purchase recommender computing device, the final financial instrument to be the approved recommended financial instrument.

15. The computer-implemented method of claim 12, further comprising the steps of:
receiving, by the instrument management system, basic financial instrument data for the user from the wallet system, the basic financial instrument data comprising data regarding at least one financial instrument;
gathering, by the instrument management system, additional financial instrument data from at least one of a bank computer system, an issuer computer system, a payment card interchange network system, the merchant computer system, and an acquirer computer system, the additional financial instrument data relating to at least one of the basic financial instrument data, the user, and a payment transaction associated with the user; and
generating, by the instrument management system, a financial instrument portfolio for the user based on the basic financial instrument data and the additional financial instrument data, the financial instrument portfolio comprising data regarding the plurality of financial instruments.

16. The computer-implemented method of claim 12, further comprising the steps of:
receiving, by the wallet system, from the user, basic financial instrument data, the basic financial instrument data comprising data regarding at least one financial instrument;
transmitting, by the wallet system, the basic financial instrument data to at least one of the purchase recommender computing device and the instrument management system; and
initiating, by the wallet system, the payment transaction with a merchant computer system.

17. The computer-implemented method of claim 16, further comprising the steps of:
receiving, by the wallet system, from the purchase recommender computing device, the recommended financial instrument;
instructing, by the wallet system, a user computer device to display the received recommended financial instrument;
instructing, by the wallet system, the user computer device to prompt the user to at least one of confirm that the recommended financial instrument be used as the final financial instrument and select another financial instrument to be used as the final financial instrument;
receiving, by the wallet system, from the user, via the user computer device, as a response to the prompt, the final financial instrument; and
transmitting, by the wallet system, the final financial instrument to the purchase recommender computing device.

18. At least one non-transitory computer-readable storage media having computer-executable instructions embodied thereon wherein, when executed by at least one processor of a purchase recommender computing device in communication with at least one memory and a display, the computer-executable instructions cause the at least one processor to:
receive, by the purchase recommender computing device, from a payment processing network, a payment request for a payment transaction, the payment request comprising a user identifier associated with a user profile for a user, the purchase recommender computing device in communication with the payment processing network, an instrument management computing device, and a wallet system, wherein the payment request is generated in response to the wallet system initiating the payment transaction with a merchant computer system;
retrieve, by the purchase recommender computing device, a financial instrument portfolio associated with the user profile based on the user identifier, the financial instrument portfolio comprising data regarding a plurality of financial instruments available for the user to use in relation to the payment transaction;
compute, by the purchase recommender computing device, a first measure and a second measure for each of the plurality of financial instruments based on the payment request and the retrieved financial instrument portfolio;
determine, by the purchase recommender computing device, for each of the plurality of financial instruments, a tier of a plurality of tiers based on the first measure;
determine, by the purchase recommender computing device, a rank for each of a plurality of candidate financial instruments of the plurality of financial instruments that correspond to a first tier of the plurality of tiers according to the second measure;
determine, by the purchase recommender computing device, a recommended financial instrument for the payment transaction by selecting a candidate financial instrument from the first tier based on the determined rank;
determine, by the purchase recommender computing device, a final financial instrument based on the recommended financial instrument;
generate, by the purchase recommender computing device, a modified payment request by updating the payment request to include the final financial instrument; and
transmit, by the purchase recommender computing device, a modified payment request for the payment transaction to the payment processing network.

19. The computer-readable storage media of claim 18, wherein the computer-executable instructions further cause the processor to:
receive, by the instrument management system, basic financial instrument data for the user from a wallet system, the basic financial instrument data comprising data regarding at least one financial instrument;
gather, by the instrument management system, additional financial instrument data from at least one of a bank computer system, an issuer computer system, a payment card interchange network system, the merchant computer system, and an acquirer computer system, the additional financial instrument data relating to at least one of the basic financial instrument data, the user, and a payment transaction associated with the user; and
generate, by the instrument management system, a financial instrument portfolio for the user based on the basic financial instrument data and the additional financial instrument data, the financial instrument portfolio comprising data regarding the plurality of financial instruments.

20. The computer-readable storage media of claim 18, wherein the computer-executable instructions further cause the processor to:
receive, by the wallet system, from the user, basic financial instrument data, the basic financial instrument data comprising data regarding at least one financial instrument;
transmit, by the wallet system, the basic financial instrument data to at least one of the purchase recommender computing device and an instrument management system; and
initiate, by the wallet system, the payment transaction with a merchant computer system.
